(19) United States
(12) Patent Application Publication
(10) Pub. No.: US 2006/0157208 A1
(43) Pub. Date: Jul. 20, 2006

(54) Corner key and method of manufacturing a screen assembly

(75) Inventor: Marc A. Annacchino, Greenfield, WI (US)

Correspondence Address: FOLEY & LARDNER LLP, 777 EAST WISCONSIN AVENUE, SUITE 3800, MILWAUKEE, WI, 53202-5308, US

(73) Assignee: Alumaroll Specialty Co., Inc.

(21) Appl. No.: 11/312,838

(22) Filed: Dec. 20, 2005

Related U.S. Application Data
(63) Continuation-in-part of application No. 10/615,719, filed on Jul. 9, 2003, now Pat. No. 6,977,021.

(51) Int. Cl. E06B 9/24

(52) U.S. Cl. 160/371

(57) ABSTRACT

A corner key and method for manufacturing a screen assembly are disclosed. The screen assembly apparatus comprises an exit ramp or incline which allows a cutting or trimming device to effectively trim the excess screen material in a corner portion of the screen assembly. The incline is configured to guide the cutting device out of the corner connector as the cutting device moves from the second screen bar to the base portion. The incline may advantageously reduce stress (e.g., undue wear, etc.) on a cutting edge of the cutting device and/or an operator (if being manufactured manually).

### CROSS-REFERENCE TO RELATED PATENT APPLICATIONS

This application is a continuation-in-part of U.S. Pat. No. 6,977,021, entitled “Screen Assembly and Method,” issued Dec. 20, 2005, the entire disclosure of which is expressly incorporated by reference herein.

### BACKGROUND

The present invention relates generally to the field of screen assemblies (e.g., window screens, door screens, etc.). More specifically, the present invention relates to corner connectors (e.g., corner keys, etc.) used in the construction and/or assembly of screen assemblies.

Screen assemblies are often used to minimize the ingress of insects and other pests into indoor areas, while still providing ventilation. Screen assemblies for windows, doors, and the like are commonly made of four elongated frame members, often referred to as screen bars (or screen bar members), of uniform cross section. These screen bars are typically roll-formed from aluminum or sheet steel, although some may be extruded aluminum. Plastic and wood are also used, but to a lesser extent. These screen bars are generally supplied from a screen bar manufacturer in lineal form and are cut to a final length by a screen assembly manufacturer.

Once cut to a final length, these screen bars can be held together at the corners with connectors or inserts, commonly referred to by persons skilled in the art as corner keys, to define a screen frame assembly. Different style corner keys are available and are designed to match the particular screen bar used. The most popular corner key allows the screen bars to be cut straight at 90 degrees at the ends. These corner keys typically are made from injection molded plastic and have a square block body to visibly fill a corner area of the screen frame assembly (i.e., a space between two mating screen bars). Attached to the body are insertion prongs that are pushed into the hollow screen bar profile to create friction fit connections. These friction fit connections, at least in part, hold the screen frame assembly together.

With the screen frame assembly formed, a screen cloth, fabric, or mesh is subsequently attached to a screen frame assembly. As used herein, the phrase “screen material” is used generally and is intended to include screen cloths, fabrics, meshes, or any other suitable ventilation material. It is generally desirable that the screen material be a light weight fabric or mesh, and stretched taut across the frame assembly to avoid unsightly sag and to allow a viewer to see through the screen with minimal visual interference. Typically, the screen material is a fiberglass yam or roving, which is coated, for example, with polyvinyl chloride (PVC), woven and heat fused. Another popular form of screen material is made by weaving drawn aluminum wire, which is subsequently painted.

The screen material may be secured to the screen frame assembly using any of a variety of techniques. For example, it is generally known to secure screen material in open grooves formed along inside edges of the screen bars using a stuffer strip known as “spline.” The open grooves formed on the screen bars are known as “spline grooves.” A spline is often a wire-like, extruded rigid plastic or foam material, although some splines are made from metal, especially for use with aluminum screens. A spline is usually round or T-shaped in cross section, but can be U-shaped, for example.

A known method of attaching a screen material to a screen frame assembly is shown in FIGS. 1 and 2. In such a method, a spline 658 is forced into a spline groove or recess 656 in the screen bar 620, with the screen material 622 sandwiched between the spline 658 and the spline groove 656. The screen material 622 is held by friction between the spline 658 and the spline groove 656 with the resulting interference fit. A lip 650 and a ledge 652, part way down one side of the groove wall, are typically included to help trap and improve the strength in retaining the screen material 622. The spline 658 and trapped screen material 622 are forced into the groove 656, usually by hand, with the use of a roller device 670, including a roller 672, as shown in FIG. 1. The term, “hand wiring,” is used to describe the action of securing the screen material 22 with spline 658 into the spline groove 656 by hand.

Known methods of capturing the screen material in the spline involve starting in one of the frame corners. The screen is then stretched taut at the next corner with one hand, keeping it straight and parallel to the edge of the mating screen bar. The spline is simultaneously held above the groove in the same manner as the screen, with the same hand. With the other hand, the installation roller is pushed along towards the upcoming corner with a firm downward force to push the spline into and trap the screen in the spline groove. This action is repeated on the second and third screen bars. On the last screen bar, most of the tension is set into the screen. On this leg, the screen is pushed into the screen bar with the installer's finger, just prior to the insertion of the spline. This pre-insertion technique reduces the final tension in the screen to the desired level. The spline is cut at the final corner with a utility knife.

Regardless of the technique used to secure the screen material to the screen frame assembly, excess screen material must be trimmed around the open groove after the screen material is secured to the screen frame assembly. To do this, a trimming device is generally used, which is pushed against the screen bar, through the screen material, just above the area of securement (e.g., just above the spline, etc.). Care must be taken to cut the screen material close to the area of securement without cutting the screen material covering the opening formed by the screen frame assembly. Particular care must be taken when cutting the screen material in the corners of the screen frame assembly. In the corners, there is no exit for the trimming device (i.e., the trimming device will encounter or engage a 90 degree wall of a corner key). Without an exit, the trimming device is susceptible to undue stress or wear if the trimming device is allowed to engage the 90 degree wall. If the trimming device is stopped short of the 90 degree wall, the screen material will not be fully trimmed and will have to be trimmed using a secondary operation.

Accordingly, there exists a need for a corner key which allows a trimming device to fully trim the excess screen material without having to suffer undue wear by engaging a 90 degree wall. There is also a need for a corner key which can provided a cutting surface for a trimming device while still providing an exit out of the corner for the trimming device. In addition, there exists a need to manufacture screen products more easily, where a screen may be secured to a frame quickly, with reduced manual labor. Further, there exists a need for a screen frame assembly that substantially reduces the level of skill and time, as well as physical force, required to attach a screen material to a screen bar and/or frame and trim the excess screen material. There is also a need for a corner key configuration which can allow for an at least partially automated method of securing a screen material to a screen frame assembly. There is also a need to provide a corner key that will be visually appealing to a user. Accordingly, it would be desirable to provide a corner key and/or screen assembly capable of accomplishing any one or more of these or other needs.

### SUMMARY

One embodiment of the invention relates to a corner connector for supporting a first screen bar relative to a second screen bar, each screen bar having a groove open toward a top surface and configured to receive a screen material that is subsequently trimmed by a cutting device. The corner connector comprises a base portion disposed between a first extension for supporting the first screen bar and a second extension for supporting the second screen bar. The base portion comprises a first end surface configured to be substantially coplanar with the top surface of the first screen bar and the top surface of the second screen bar. The corner connector further comprises a first incline defined by the base portion and ascending from a point below the first end surface. The first incline is configured to guide the cutting device out of the corner connector as the cutting device moves from the second screen bar to the base portion. The corner connector further comprises a second incline defined by the base portion and ascending from a point below the first end surface. The second incline is configured to guide the cutting device out of the corner connector as the cutting device moves from the first screen bar to the base portion.

Another embodiment of the invention relates to a screen assembly. The screen assembly comprises a screen material, a plurality of frame members secured together to form a frame assembly, each frame member having a groove for receiving the screen material, and a plurality corner connectors disposed between adjacent frame members, each corner connector including a base portion defining a pair of exit ramps. The exit ramps comprises a sloped surface configured to guide a cutting device used to trim the screen material

Another embodiment of the invention relates to method of manufacturing a screen assembly. The method comprises the step of forming a frame assembly by securing at least a first frame member and a second frame member to a corner connector. The first frame member, the second frame member, and the corner connector cooperate to define a substantially continuous groove about the frame assembly. The method further comprises the step of positioning a screen material over the frame assembly so that a portion of the screen material overlays the groove, securing the screen material in the groove, and trimming the screen material with a cutting device. The cutting device is guided out of the corner connector by an incline defined by the corner connector.

### BRIEF DESCRIPTION OF THE DRAWINGS

FIG. 1 shows a cross-sectional view of a conventional method of installing screen into a screen frame using spline and a hand roller.

FIG. 2 shows a cross-sectional view of screen installed into a screen frame using spline, as is conventional in the art.

FIG. 3 shows a partial view of a screen assembly according to an exemplary embodiment.

FIG. 4 shows a perspective view of a corner portion of a screen frame according to an exemplary embodiment.

FIG. 5 shows a top view of a corner key according to an exemplary embodiment.

FIG. 6 shows a side view of the corner key of FIG. 5.

FIG. 7 shows a partial perspective view of the corner key of FIG. 5.

FIG. 8 shows a top view of a corner key according to another exemplary embodiment.

FIG. 9 shows a partial perspective view of the corner key of FIG. 8.

FIG. 10 shows a block diagram for a process used in securing a screen to a screen frame according to an exemplary embodiment.

FIG. 11 shows a control architecture of a screen assembly apparatus according to an exemplary embodiment.

FIG. 12 shows a screen assembly apparatus according to an exemplary embodiment.

FIG. 13 shows a vacuum system for securing a screen frame to a screen assembly apparatus according to an exemplary embodiment.

FIG. 14 shows a screen assembly apparatus according to an exemplary embodiment.

FIGS. 15-17 show a process for mounting screen material to a screen frame according to an exemplary embodiment.

FIGS. 18-21 show a process of seating a screen material within a slot provided on a screen frame according to an exemplary embodiment.

FIG. 22 shows a screen assembly apparatus according to an exemplary embodiment.

FIG. 23 shows a screen assembly apparatus with a dual head configuration according to an exemplary embodiment.

FIG. 24 shows a computer control system for a screen assembly apparatus according to an exemplary embodiment.

FIG. 25 shows a screen assembly apparatus according to another exemplary embodiment.

FIG. 26 shows a trimming device of the screen assembly apparatus of FIG. 25 according to an exemplary embodiment.

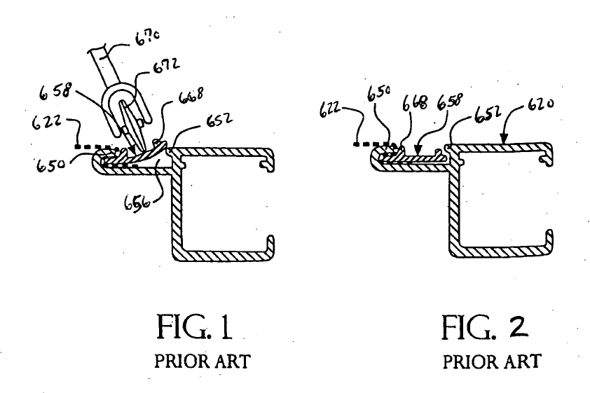

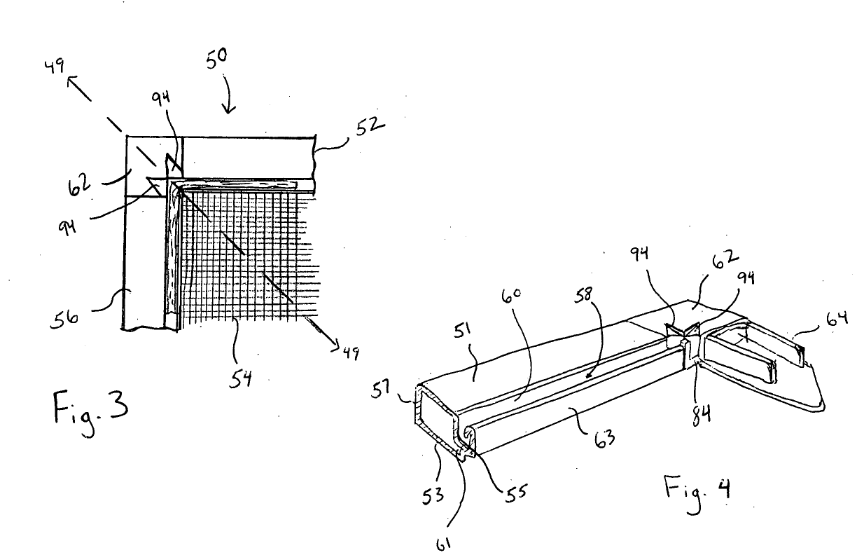

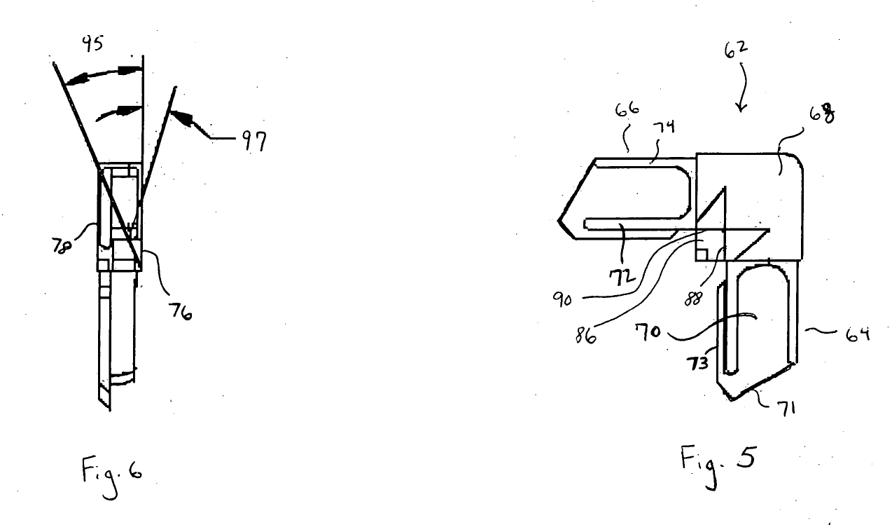

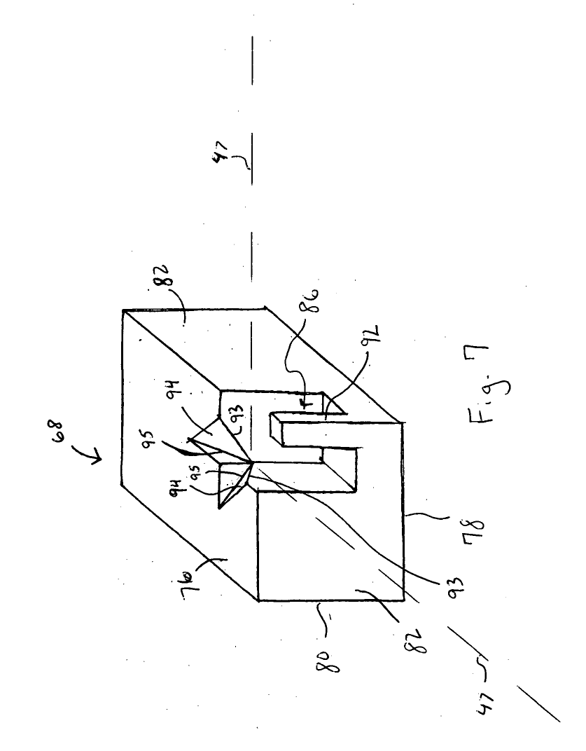

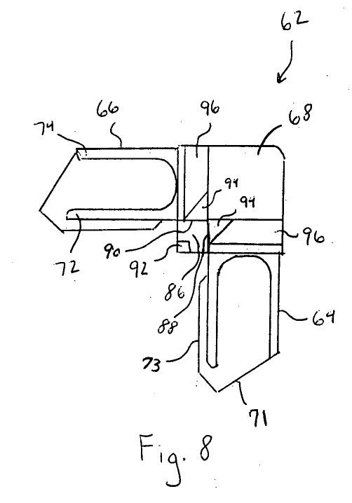

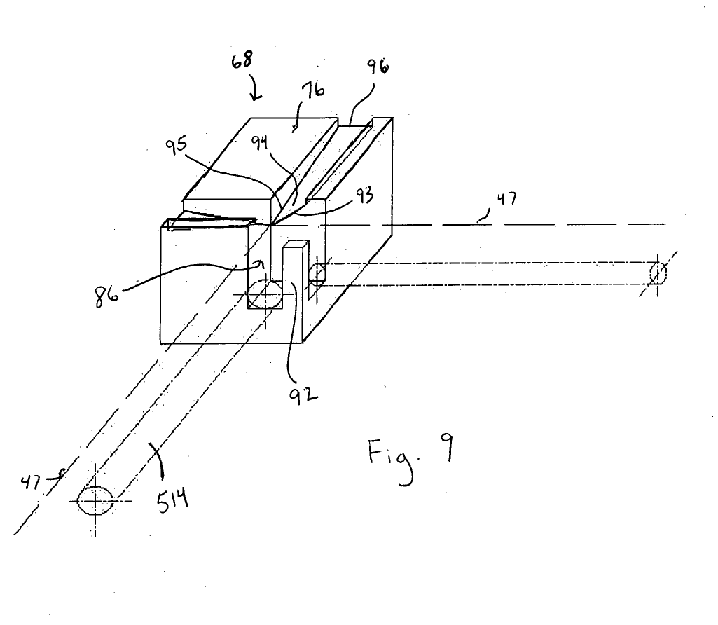

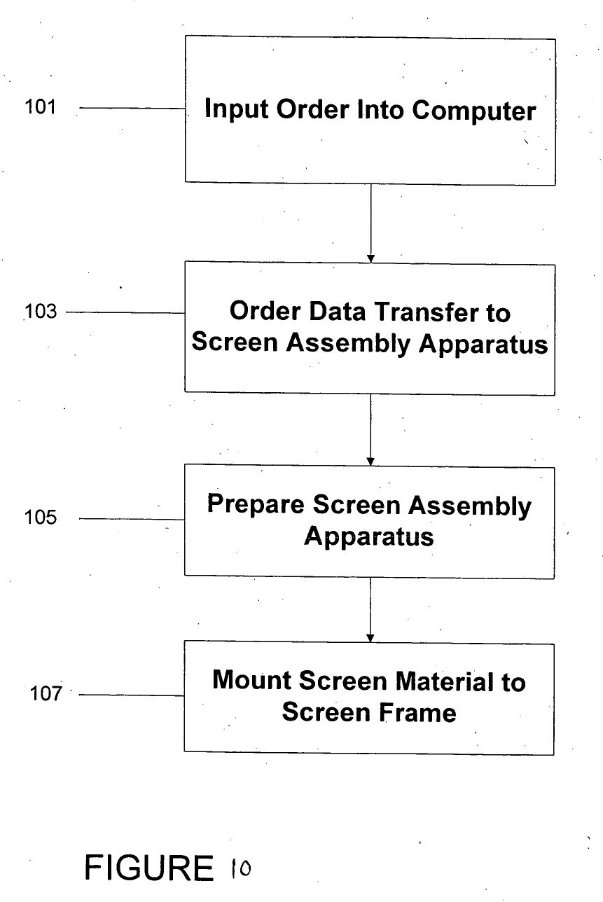

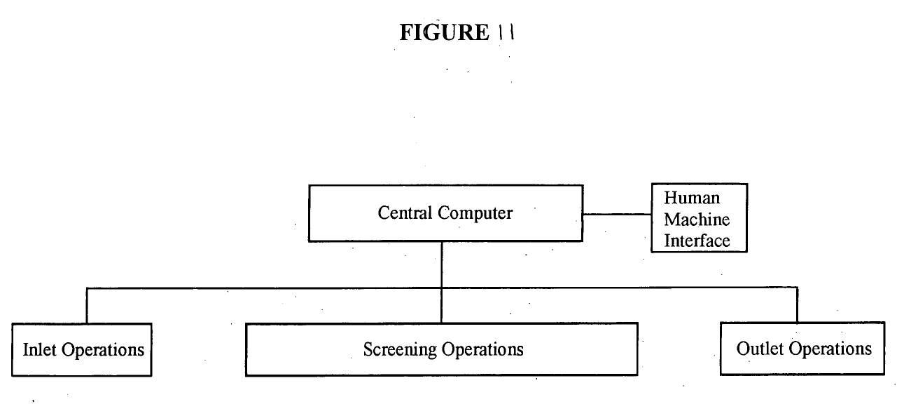

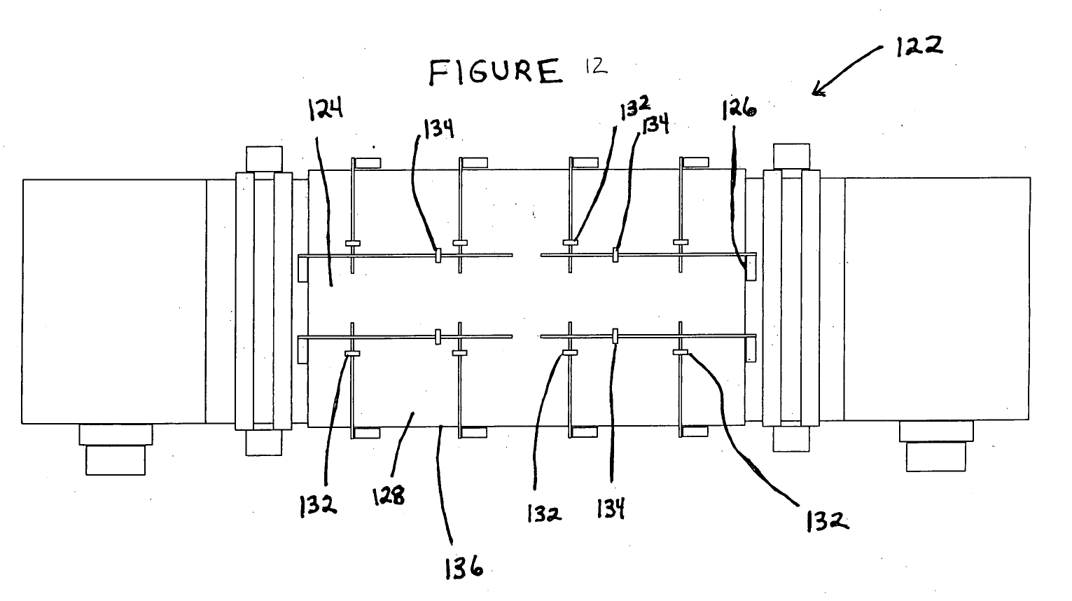

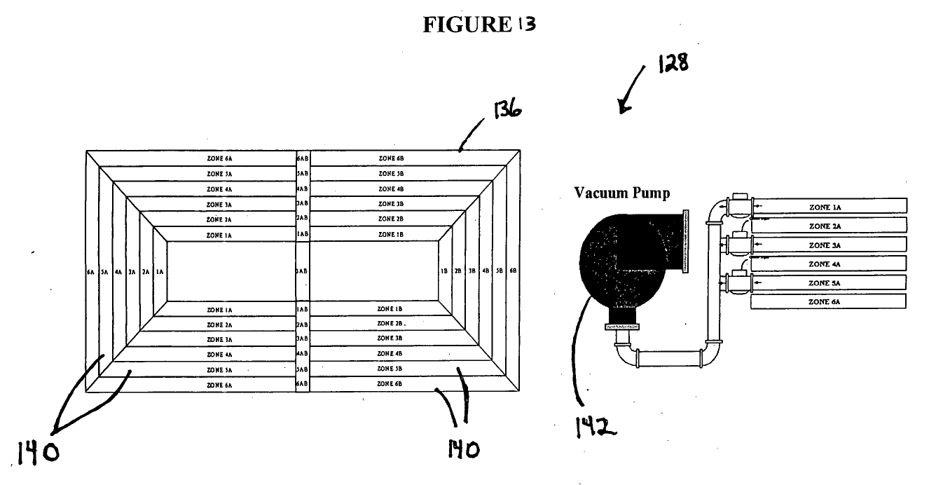

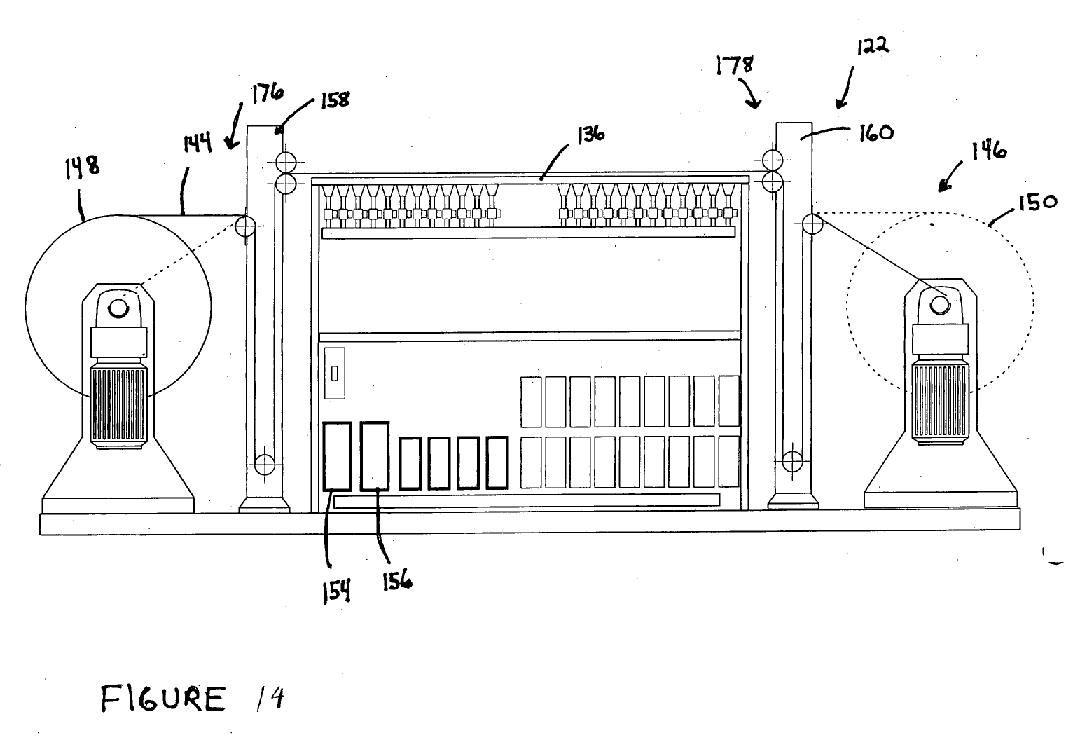

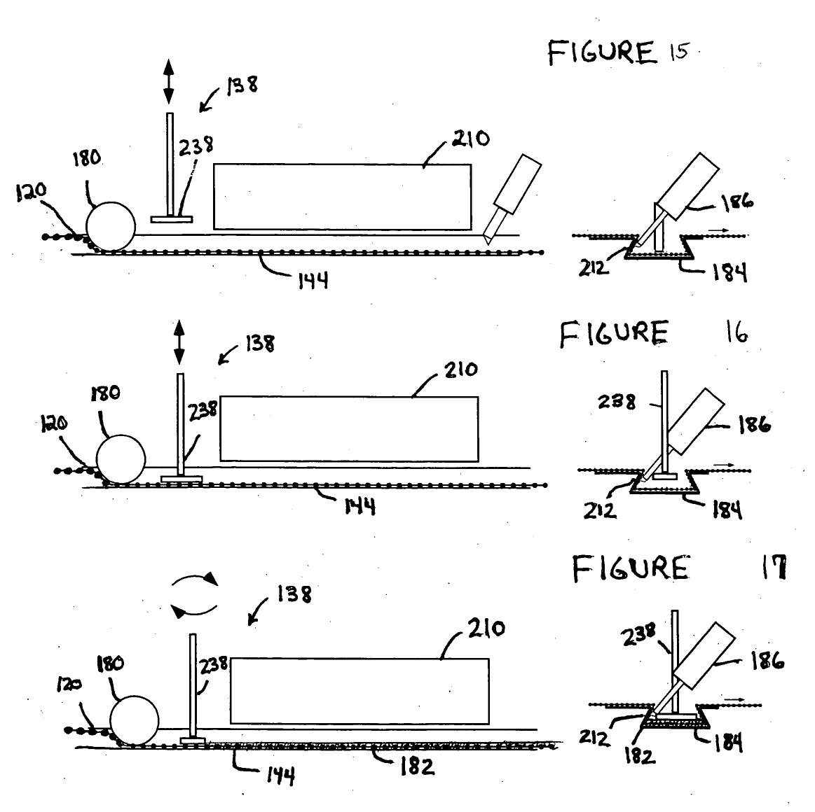

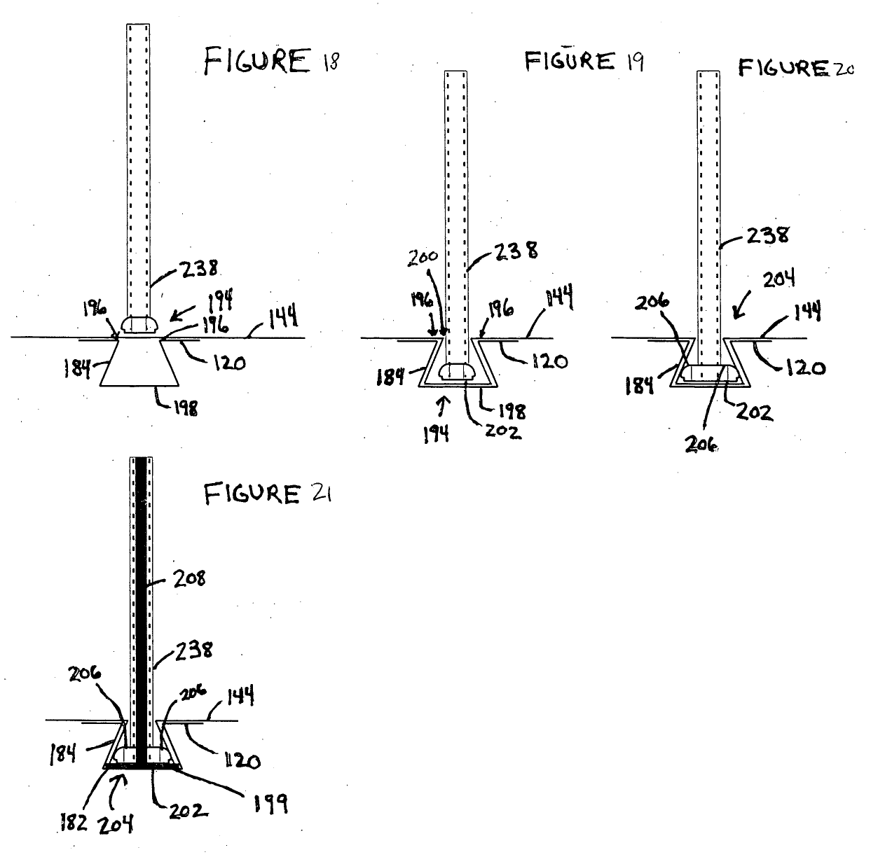

### DETAILED DESCRIPTION

Referring generally to the FIGURES, a screen assembly and methods of manufacturing the screen assembly are provided according to exemplary embodiments. The screen assembly and the methods of manufacturing the screen assembly disclosed provide an economical and improved means of securing a screen material to a screen frame assembly and/or trimming excess screen material from the screen frame assembly. Generally, the screen assembly includes one or more corner connectors (referred to broadly herein as “corner keys”) provided with one or more inclines or “exit ramps” which allow a cutting or trimming device to effectively trim the excess screen material in a corner portion of the screen assembly. The one or more inclines or exit ramps may also advantageously reduce stress (e.g., undue wear, etc.) on a cutting edge of the cutting device and/or an operator (if being manufactured manually). Further still, the one or more inclines or exit ramps may allow for an improved method of manufacturing (e.g., a method wherein securement of the screen material to a screen bar begins at a centerline of the screen bar and moves towards the corners, etc.).

It should be noted at the outset that the screen assembly and the methods of manufacturing the screen assembly disclosed are suitable for a number of environments or applications including, but not limited to, residential and/or commercial windows, doors, partitions, or the like.

Referring to initially to FIG. 3, a screen assembly 50 is partially shown according to an exemplary embodiment. The screen assembly 50 generally comprises a screen frame assembly 52 surrounding a screen material 54. The screen material 54 may be any known or otherwise suitable material for providing ventilation while at least partially inhibiting the passage of certain contaminants (e.g., pests, insects, dust particles, leaves, etc.). For example, the screen material 54 may be formed of any cloth, metal, composite, fabric, etc. material provided as a mesh, weave, matrix, lattice, etc. According to an exemplary embodiment, the screen material 54 is formed of drawn aluminum which is subsequently woven to provide for the screen material 54.

The screen frame assembly 52 is generally formed of a plurality of frame members (e.g., frame sections, segments, etc.), such as four elongated screen bars 56, which are arranged relative to each other to form the screen frame assembly 52. The screen bars 56 are generally tubular members having a substantially uniform cross section. The cross section of the screen bar 56 is designed to minimize the overall weight of the screen assembly 50, while also providing a degree of rigidity to the screen assembly 50 (e.g., to reduce deflection, torsional movement, etc.). The screen bar 56 may have any of a variety of known or otherwise suitable cross sections providing for these and/or other design criteria.

According to an exemplary embodiment, the screen bars 56 are rolled-formed from aluminum or sheet metal and provided as generally rectangular members. According to various alternative embodiments, the screen bars 56 may be formed via an extrusion operation or any other suitable formation process. Referring to FIG. 4, the screen bars 56 are shown as including a first or top surface 51, a second or bottom surface 53, a third or inner side surface 55, and a fourth or outer side surface 57. The top surface 51, the bottom surface 53, the inner side surface 55, and the outer side surface 57 cooperate to define a substantially rectangular cross-section configured to receive a member used in supporting a first screen bar 56 relative to an adjacent screen bar 56.

The screen bars 56 are further shown as including a structure configured to receive and/or retain the screen material 54. For example, referring to FIG. 4, the screen bar 56 includes an open groove (e.g., selvage or stuffer groove, slot, etc.), shown as a spline groove 58, formed along an inner edge 60 of each of the screen bar 56 to provide a structure for receiving and/or retaining a portion of the screen material 54. The spline groove 58 is partially defined by the inner side surface 55. When the screen bars 56 are arranged to form the screen frame assembly 52, the spline groove 58 extends continuously about the screen frame assembly 52. As detailed below, an edge of the screen material 54 is applied over the spline groove 58 and is subsequently inserted into and secured within the spline groove 58 using a stuffer strip or spline, a curable material, or any other suitable technique.

Referring to FIG. 4, the screen bar 56 is further shown as including an internal channel 61. The internal channel 61 extends continuously at least partially disposed beneath the spline groove 58. The internal channel 61 is formed as a result of the formation of a flange 63 which partially defines the spline groove 58. As detailed below, the internal channel 61 is configured to slidably receive a member used in supporting a first screen bar 56 relative to an adjacent screen bar 56.

Referring further to FIG. 3, a corner portion of the screen assembly 50 is shown according to an exemplary embodiment. To secure two mating or adjacent screen bars 56 relative to each other, a connector (e.g., fastener, insert, etc.), shown as a corner key 62, is provided. The corner key 62 is configured to secure a first screen bar at an orientation relative to a second screen bar. According to an exemplary embodiment, the corner key 62 is a substantially L-shaped member configured to support a first screen bar 56 and a second screen bar 56 in a manner such that the first screen bar 56 is substantially perpendicular to the second screen bar 56 (i.e., the screen bars 56 form a right angle). According to various alternative embodiments, the corner key 62 may be configured to support a first screen bar and a second screen bar at an orientation other than a right angle.

Referring further to FIGS. 4 and 5, the corner key 62 is shown as comprising a first extension (e.g., prong, arm, insert, etc.), shown as a first leg 64, and a second extension (e.g., prong, arm, insert, etc.), shown as a second leg 66. The first leg 64 and the second leg 66 outwardly extend from a base portion (e.g., central location, etc.), shown as a corner portion 68. The corner portion 68 is disposed between the first leg 64 and the second leg 66 and is configured to provide a body which visibly fills a void otherwise left in the corner area between adjacent screen bars 56. The corner portion 68 is dimensioned and/or shaped to provide a visually continuous screen frame assembly.

The first leg 64 and the second leg 66 may have any of a variety of configurations suitable for receiving a free end of the screen bar 56. According to an exemplary embodiment, the first leg 64 and the second leg 66 generally include a platform 70 (e.g., base, bottom wall, etc.), a first side wall 72, and a second side wall 74. The first side wall 72 and the second side wall 74 are arranged such that they upwardly extend from the platform 70 at an orientation that is substantially perpendicular to the platform 70. The platform 70 defines a cam surface or leader 71 and a side flange 73. The platform 70, the first side wall 72, and the second side wall 74 cooperate to form a relatively rigid member configured to slidably engage the screen bar 56 in a telescopic manner. The leader 71 is configured align the corner key 62 with the screen bar 56 as the corner key 62 is being slidably inserted into the screen bar 56, while the side flange 73 is configured to slidably engage the internal channel 61 of the screen bar 56. Engagement of the corner key 62 and the screen bar 56 creates a friction fit for securing the screen bar 56 relative to the corner key 62.

As stated above, the first leg 64 and the second leg 66 extend outwardly from the corner portion 68. According to an exemplary embodiment, the corner portion 68 generally includes a first end wall 76 (e.g., platform, top, top surface, etc.), a second end wall 78 (e.g., platform, bottom, bottom surface, etc.) (shown in FIG. 6), outer side walls 80 (e.g., outer edge surface, peripheral surface, etc.), and inner side walls 82 (e.g., inner edge surface, peripheral surface, etc.). The first end wall 76, the second end wall 78, the outer side walls 80, and the inner side walls 82 cooperate to define a substantially rectangular portion configured to provide the visual appearance of a continuous screen frame assembly.

The first end wall 76 is configured to be substantially coplanar with the top surface 51 of the screen bar 56, while the second end wall 78 is configured to be substantially coplanar with the bottom surface 53 of the screen bar 56 when the screen bar 56 is coupled to the corner key 62. The inner side walls 82 provide a surface from which the first leg 64 and the second leg 66 outwardly extend at orientations that are generally perpendicular to the respective inner side wall 82 from which the first leg 64 and the second leg 66 extend. Each inner side wall 82 defines a shoulder 84 (shown in FIG. 4) which provides a positive stop for the screen bar 56 as the screen bar 56 slidably engages the corner key 62. According to an exemplary embodiment, the shoulder 84 extends substantially continuous about the first leg 64 and the second leg 66.

The corner portion 68 further includes a missing portion or notch (shown in FIG. 7 as a corner channel 86). The corner channel 86 is defined by a first channel wall 88 and a second channel wall 90. The first channel wall 88 and the second channel wall 90 are substantially perpendicular to each other and are each configured to be substantially coplanar with the inner side surface 55 of the corresponding screen bar 56. The corner channel 86 functions as a transition between the spline grooves 58 of adjacent screen bars 56 and is configured to receive and/or retain the screen material 54. According to an exemplary embodiment, the corner portion 68 further includes a projection, shown as a post 92, upwardly extending from the corner channel 86. The post 92 is aligned with the inner side walls 82 but spaced apart therefrom to visually divide the corner channel 86 into a pair of perpendicular channels. The post 92 may also provide a positive stop for the flange 63 as the screen bar 56 slidably engages the corner key 62. According to various alternative embodiments, the post 62 may have a reduced height or may be eliminated entirely.

As stated above, the corner key 62 includes a structure which allows a cutting device to effectively trim excess screen material 54 in a corner portion of the screen frame assembly 52 after the screen material 54 has been applied to the spline groove 58. Such a structure, which is referred to broadly herein as an exit ramp or incline 94 (e.g., surface, cam surface, slant, slope, etc.) creates a passage or pathway in the corner portion 68 which allows the cutting device to exit the corner key 62 after trimming the excess screen material 54 without having to engage a 90 degree end wall. Generally, the corner key 62 includes a pair of inclines 94 (one associated with each screen bar 56). The pair of inclines 94 are substantially symmetrical about an axis 49 (shown in FIG. 3) extending diagonally across the first end wall 76. Providing the incline 94 may advantageously prolong the useful life of the cutting device by reducing the stress otherwise applied to the cutting device from engaging a 90 end wall. Providing the incline 94 may also allow for a more uniform or consistent trimming of the excess screen material 54. Providing the incline 94 may also allow for an improved method of manufacturing the screen assembly 50 (e.g., a method wherein securement of the screen material 54 to the screen bar 56 begins at a centerline of the screen bar 56 and moves towards the corner key 62, etc.).

Referring to FIG. 7 in particular, the incline 94 is shown according to a first exemplary embodiment. The incline 94 is defined by the corner portion 68 of the corner key 62 and ascends from a point below the first end wall 76 (e.g., a top portion of the second channel wall 90, etc.) toward the first end wall 76. The incline 94 is configured to be substantially aligned with the spline groove 58 of the screen bar 56 for guiding a cutting device out of the corner key 62 after cutting excess screen material 54 along the screen bar 56. According to an exemplary embodiment, the incline 94 has more than one angle or component of inclination (i.e., the incline 94 is a compound incline or ramp).

The incline 94 is shown as including a first component 93, which upwardly ascends toward the outer side wall 80 of the corner portion 68, and a second component 95, which upwardly ascends toward the inner side wall 82 of the corner portion 68. The first component 93 of the incline 94 provides the passage or pathway out of the corner key 62 for the cutting device moving between a first screen bar 56 and the corner key 62, while the second component 95 of the incline 94 provides a surface against which the cutting device may trim the excess screen material 54 when moving between an adjacent screen bar 56 and the corner key 62.

It should be noted that the incline 94 may be provided as a substantially linear surface as shown, or alternatively, may be provided as a curvilinear surface, a stepped surface, a combination of linear and curvilinear surfaces, or as any other suitable surface defining an incline. Further, according to various design criteria, the angle or slope at which incline 94 ascends (for both the first component 93 and the second component 95) may vary. According to an exemplary embodiment, the first component 93 and the second component 95 are provided angles 95, 97 (shown in FIG. 6) that are between approximately 10 degrees and approximately 30 degrees relative to the first end wall 76. The angle of the first component 93 and the angle of the second component 95 may be substantially the same, or alternatively, the two angles may vary. According to an exemplary embodiment, the angle of the second component is less prominent (i.e., smaller, more gradual) than the angle of the first component.

Referring to FIGS. 8 and 9, the incline 94 is shown according to a second exemplary embodiment. In such an embodiment, the corner portion 68 of the corner key 62 is further shown as including a pair of channels 96 which are aligned substantially perpendicular to each other. The incline 94 is provided within the channel 96. The channels 96 are configured to be substantially collinear with the spline grooves 58 of the screen bars 56. The channels 96 extend between the outer side wall 80 and either the first channel wall 88 or the second channel wall 90. The channels 96 may provide visual continuation of the spline grooves 58, may provide increased clearance from a cutting device as it exits the corner key 62, and/or may visually conceal the incline 94. The bottom surfaces of the channels 96 may be substantially parallel with the first end wall 76 of the corner portion 68, or alternatively, may be provided at an angle relative to the first end wall 76. For example, the bottom surfaces of the channels 96 may ascend toward the outer side wall 80.

The corner key 62 may-be formed of any of a variety of suitable materials. According to an exemplary embodiment, the corner key 62 is formed of a molded plastic material including, but not limited to, polyurethane. According to various alternative embodiments, the corner key 62 may be formed of any other suitable material (e.g., metal, composite, wood, etc.). According to an exemplary embodiment, the corner portion 68, the first extension 64, and the second extension 66 are integrally formed as a single unitary body in a single mold by an injection molding operation. According to various alternative embodiments, one or more of the extensions may be provided as a separate component or member that can be coupled to the corner portion 68 in any suitable manner (e.g., snap-fit, a welding operation, adhesive, mechanical fastener, etc.). According to an exemplary embodiment, the incline 94 (and the channel 96 if provided) are integrally molded in the corner portion 68. According to various alternative embodiments, the incline 94 (and the channel 96 if provided) may be formed by removing (e.g., cutting, milling, etc.) portions of the corner portion 68 after the corner portion 68 is formed.

Turning now to the manufacturing of the screen assembly 50, the screen material 54 may be secured to the screen frame assembly 52 using any of a variety of suitable operations or methods. For example, the screen material 54 may be secured to the screen frame assembly 52 through a manual process (e.g., the conventional hand wiring process detailed above, etc.), an at least partially automated process utilizing a curable compound, or an at least partially automated process utilizing a stuffer strip or spline-pressed over the screen material 54 and into the spline groove 58. According to various alternative embodiments, the screen material 54 may be secured to the screen frame assembly 52 using any other suitable technique.

Referring to FIG. 10, a block diagram showing an at least partially automated process used in securing screen material 54 to a screen frame assembly 52 according to an exemplary embodiment. The process generally begins with the step of inputting an order 101 into a main computer where the order includes information such as the dimensions of the particular screen frame to be created. Next, the order data is transferred 103 to a controller of a screen assembly apparatus. The controller will use this transferred order data to prepare 105 the screen assembly apparatus to construct a screen assembly 50 according to the order data input in the first step. For example, a supply of screen material 54 will be positioned on the screen assembly apparatus and a screen frame assembly 52 will be positioned in the screen assembly apparatus and prepared to receive the screen material 54. Next, the screen assembly apparatus will mount the screen material 54 to the screen frame assembly 52 through the use of a variety of components (e.g., such as a dispensing head, curable compound, spline, a cutting device for trimming excess screen material, etc.). Finally, the assembled screen assembly 50 will be transferred from the screen assembly apparatus for shipping and processing and the screen assembly apparatus will be prepared for a repetition of the process described above.

At step 101, an order is inputted into a main computer. The order is made by a user overseeing the screening process. The order may include information such as the dimensions of the particular screen frame to be created. Next, the order data is transferred at step 103 from a main computer to a controller of a screen assembly apparatus. Further, the computer sends data based on the order to other parts of the screen assembly apparatus for readjustment depending on particular requirements. Thus, each of the subsystems of the apparatus, including but not limited to those described in this disclosure, may be under the control of the main computer. For example, the main computer could control an inlet section, a screening mechanism, an outlet section, etc. Each section could accept central command orders and operate independently. The control architecture of the machine is based on two different protocols. The first protocol is a high speed communication link that controls the axis movement of the apparatus as well as the ancillary input, outputs, and sequencing of the apparatus. The second protocol is hierarchical communication link used for downloading order and readjustment information and uploading diagnostic information to the main computer. As shown in FIG. 11, the computer controls inlet operations, screening operations, and outlet operations.

FIG. 12 shows an exemplary structure used to carry out step 105 in greater detail. FIG. 12 shows a screen apparatus 122 which includes an inlet section 124, an end stop 126, and vacuum system 128. To adjust a screen frame, a manual or automatic feed operation may be used to guide the screen frame into an inlet section 124 of screen apparatus 122. In a manual system, an operator loads a screen frame into screen apparatus 122 at inlet section 124. The screen frame may be adjusted by the operator and stopped with a programmable end stop. In an automatic system, these operations are performed automatically under the control of a computer system. According to an exemplary embodiment, screen apparatus 122 is capable of receiving (e.g., being fed) screen frames from about 18×12 inches up to and including about 48×96 inches. The machine is adapted to readjust its parameters based on the particular dimensions of an order. According to various alternative embodiments, the screen apparatus 122 may be configured to receive screen frames having any of a variety of sizes.

Referring to FIG. 13, when loading a screen frame into position within apparatus 122, a general vacuum/pressure zone 140 (e.g., position) for securing the screen frame may be identified via a look-up table developed by correlating screen size to the most relevant vacuum zone 140. This procedure may be done either manually or automatically by a computer system. Based on the zone that is determined, the screen frame may then be loaded into the prescribed position. Locating tangs 132 and stops 134 shown in FIG. 12 are used to hold the screen frame in position. The locating stops 134 and tangs 132 may be readjusted depending on a particular size for a given screen. In general, the size of the screen will dictate the position of locating tangs 132. According to an exemplary embodiment, the locating tangs may be adjusted by electromechanical means so as to locate the screen frame and also pre-stress it to prevent hour-glassing of the frame. According to a preferred embodiment, the overall feeding process occurs within a few seconds, and more preferably, within about one second regardless of screen size.

According to alternative embodiments, the inlet section may include additional adjustable guides. For example, the inlet section may include belts and/or rollers for locating and affixing the frame for any secondary screening operations. These guides may be made from materials that will be hard enough for good wear characteristics and pliable enough for effective location of the frame. The guides may be adjusted so that the screen can be located in a rapid and accurate manner (e.g., by using a screw and nut fastening arrangement). A programmable end stop may be used to stop the screen in the line feed axis. As described above, operation of the inlet section on the screen assembly apparatus may be controlled by a computer system comprising operational software. The computer system can handle safety interlocks, the machine sequences and diagnostic procedures. The inlet section can also be equipped with sensors for feeding basic status information to the computer system.

In step 105, a vacuum system 128 is used to removably secure a screen frame to a platen 136 (e.g., stationary portion of the screen frame apparatus). Vacuum system 128 and platen 136 are shown in greater detail in FIG. 13. According to a preferred embodiment, vacuum system 128 keeps the screen frame in alignment with a plurality of compound dispensing heads that are configured to dispense compound into the frame and orient in x, y and z coordinates.

According to a preferred embodiment shown in FIG. 13, vacuum system 128 consists of zones 140 on platen 136 that are under solenoid control. Vacuum system 128 further comprises a vacuum pump 142 adapted to control the pressure applied at specific zones 140. For example, FIG. 13 shows vacuum pump 142 coupled to various zones 140. In order to create vacuum system 128, the screen assembly apparatus can utilize relatively simple contactors and fan/vacuum systems in combination with solenoids. By controlling only certain solenoids, an efficient vacuum system can be created that will operate on selective frame components rather than the entire platen 136. Vacuum system 128 is adapted to reverse the direction of the air flow from the application of negative air pressure (e.g., vacuum) used during the vacuum clamping operation of the screen frame to the application of a positive air pressure operation which can be used to facilitate the ejection of the completed screen. For example, three way valving may be used for the air line feeding the specific zones. In addition, the pressure cycle may act as a purge for the small holes in the platen to prevent dirt and extraneous material from becoming lodged therein.

In step 105, screen material 144 is advanced along screen assembly apparatus 122 for attachment to a screen frame. As shown in FIG. 14, a screen advance system 146 (e.g., material feed-to-stop system) provides an independent feed-to-stop system that advances screen material 144 from payoff roll or unwind reel 148 to take-up roll/reel 150 across platen 136 where the screen frame is screened. Feed-to-stop system 146 is preferably controlled by two drives 154, 156 powering two motors 158, 160 through right angle gearboxes. High speed linear motors 158, 160 power a material indexer that positions screen material 144 above platen 136. Unwind and take-up reels 148, 150 and drive/motor combinations 154, 156, 158, 160 are used to create the appropriate tension for screen material 144. In general, the actual required torque may be determined empirically through machine use. According to a preferred embodiment, unwind reel 148 and take-up roll/reel 150 are of constant speed. Linear motors 148 and 150 perform high speed positioning by gathering screen material 144. For example, as linear motors 148, 150 move downward, they gather screen material 144 at the material indexer. Linear motors 148, 150 then retract upwards to position screen material 144 across platen 136.

Material feed-to-stop system 146 is preferably an integrated part of screen apparatus 122. Apparatus 122 can handle a screen roll of about 55 inches wide. Since different size screens may be used with this set-up, screen advance system 146 may feed screen material 144 on a first side 176 and then index on a second side 178 on rewind. The illustrated machine is preferably bi-directional so that take-up reel 150 becomes an unwind or feed reel in order to allow use of a wider roll. This also eliminates waste and maximizes usage of screen material. The rewind operation is preferably completely symmetrical with respect to the unwind operation.

According to a preferred embodiment, the material is fed off of payoff reel 148 at a rate of about 1 foot per second. However, the rate of the unwind and rewind may be adjusted based on the size of the screen to be made. The length of the material across platen 136 may be up to about 8 feet and the width of the material across platen 136 may be up to about 6 feet.

After the web of screen material is properly positioned above the screen frame assembly 52, the next step in the process is to secure screen material 54 to the screen frame assembly 52. The process of securing the screen material 54 to the screen frame assembly 52 utilizes one or more dispensing heads and may require multiple steps. Referring generally to FIGS. 15 through 24, a process for securing the screen material 54 to the screen frame assembly 50 is shown according to a first exemplary embodiment. Such an embodiment relies on a curable compound to secure the screen material 54 to the screen frame assembly 52. Referring to FIGS. 15-17 in particular, the sequence of steps for securing the screen material 54 to the screen frame assembly 50 according to the first exemplary embodiment is shown. The steps include seating the screen material 54 into screen frame assembly 52 with seating wheel 180 and dispensing heads 238, dispensing curable compound 182 into slot 184, curing compound 182 with ultraviolet light to create a bond for retention of screen material 144 in slot 184, and trimming excess screen material with a trimming device 186 (e.g., ultrasonic knife).

FIGS. 18 through 21 show the process of seating screen material 144 within slot 184 in greater detail. As detailed above, screen material 144 is positioned over screen frame 120 by the reels. As screen material 144 is advanced between the reels, a plurality of seating tools 238 (e.g., sub-heads) located on the mounting devices are positioned with respect to screen frame 120 and slot 184. Heads 238 are positioned by linear motors to a desired location for proper insertion into slot 184 located on screen frame 120. The use of linear motors can minimize appreciable wear on items and increase accuracy and repeatability. Another advantage of linear motors is that they are very fast and have very dynamic response with no appreciable mechanical resonance.

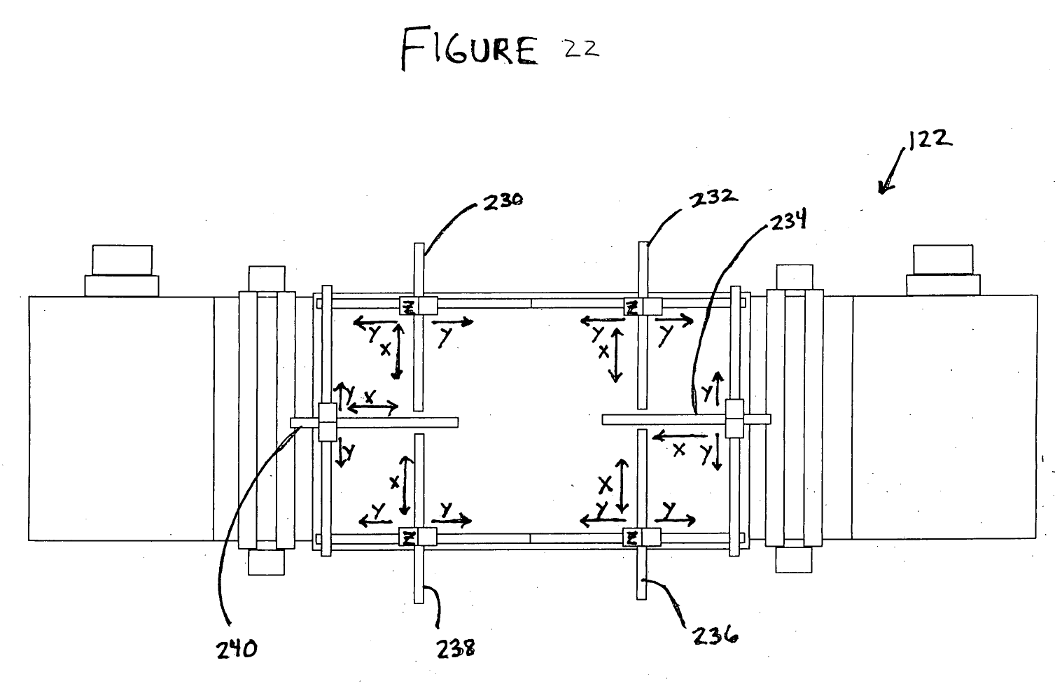

Referring to FIG. 22, screen apparatus 122 includes six 3-axis systems 230, 232, 234, 236, 238, 240 that control the positioning of dispensing heads in screen frames. These six systems 230, 232, 234, 236, 238, 240 have an x-axis, a y-axis and a z-axis. The z-axis is used to move the dispensing and curing head vertically up and down with respect to the screen frame. As shown in FIG. 22, the x-axis motors are used to position the dual head “Y” axis over the screen frame. The z-axis then lower the dispensing heads into the screen frame. Preferably, all systems are identical and all six have a 12-inch stroke. Upon the completion of load step 107 and screen advance step 107, the linear motors are preferably positioned for engaging the screening material into the screen frame. Computer system 130 sends parametric information to the drive controllers for the y- and x-axes and the z-axis for retraction from the previous screen completion sequence.

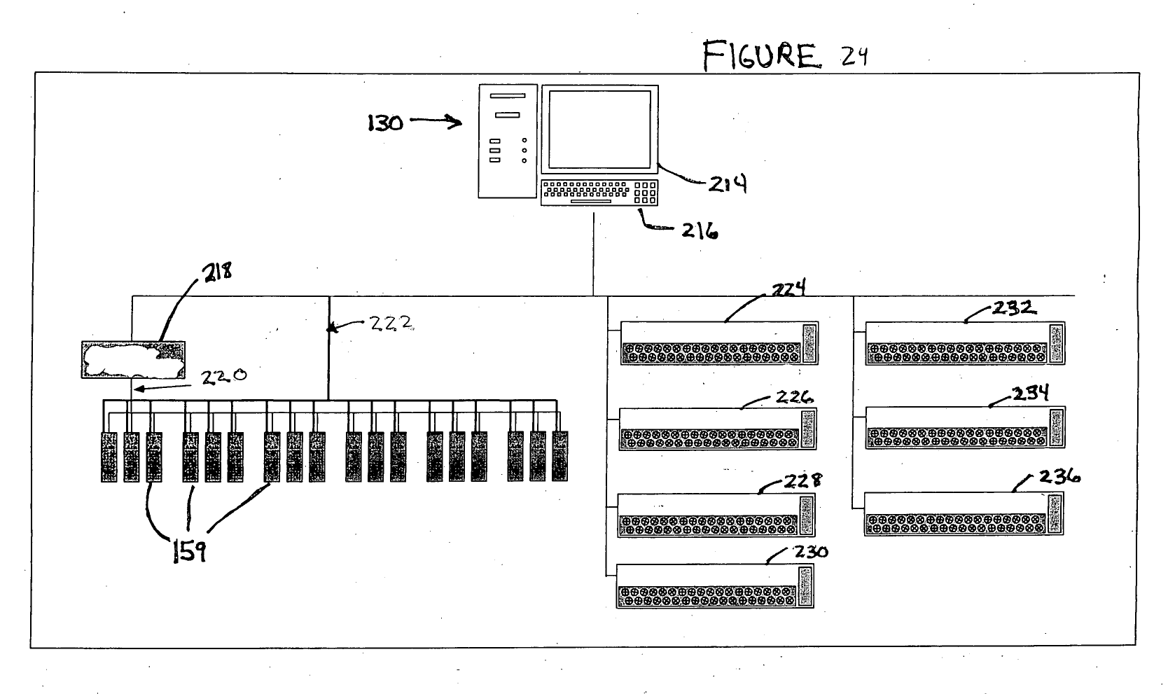

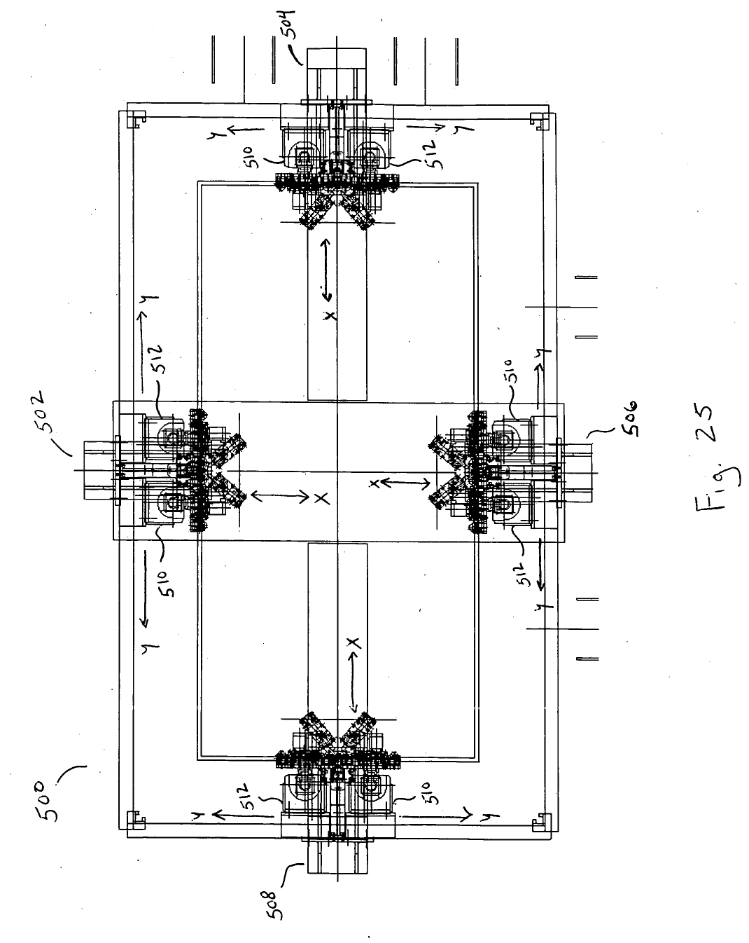

Commands from a computer system 130 (shown in FIG. 24) position systems 230, 232, 234, 236, 238, 240 at appropriate locations along different sized frames. In general, the y-axes represent areas of a screening machine that will engage a frame along its length, top and bottom. These axes bring dispensing heads closer to the frame rails. Once the y-axes engage the edges of the frame rails, the z-axes lower to allow the dispensing heads to engage the screen material and frame slot and the x-axes become ready to traverse the frame slot to seat and attach the screen to the frame. The y-axes then traverses away from centerline to begin additional operations.

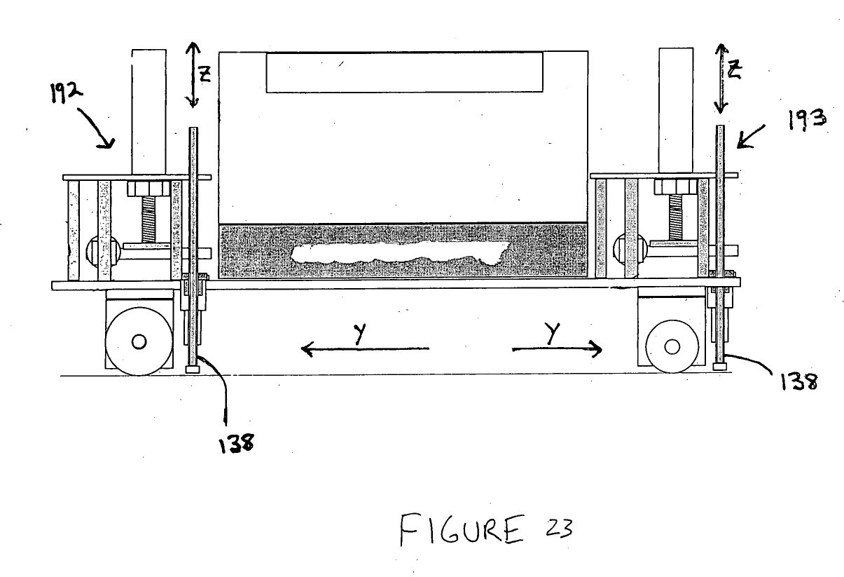

As shown in FIG. 23, dispensing heads 138 preferably have a dual head configuration for screen material mounting such that two separate dispensing head systems 192, 193 work in-line with one another. Head systems 192, 193 may start at a location determined by a computer (e.g. as shown in FIG. 24). However, the configuration of the corner key 62 (with the inclines 94) advantageously allows the systems to start at a centerline of the screen bar and move towards the corners. As the screening process begins, the y-axes traverse away from the starting location to a computer controlled end location. The z-axes then retract and the y-axes return to the starting location. If the next screen is a different size, the x-axes advance or retract as appropriate. Alternatively, any number of configurations and sequences for the systems are possible. For example, two separate dispensing head systems may move toward one another, away from one another, parallel to one another, before or after one another, etc. Further, the disclosed system is not limited to just dual head designs. The dispensing heads may include any number of configurations (e.g., single heads, triple heads, etc.).

Once systems 230, 232, 234, 236, 238, 240 are positioned by a computer (e.g., computer 130 shown in FIG. 24), the dispensing heads seat the screen material in the screen frame. First, as shown in FIG. 15, seating wheel 120 pushes screening material 144 down into slot 184. Next, the seating tools 238 are moved into position, including an initial position of a first configuration 194. FIG. 18 shows seating tool 238 (e.g., part of the dispensing head) positioned over slot 184 in a first configuration 194. First configuration 194 allows tool 238 to slip downward between the sides 196 of slot 184 since slot 184 has a generally tapered shape inward from base 198 to opening 200 (as shown in FIG. 19). Once the head 202 of seating tool 238 is located in slot 184, head 202 is rotated approximately 25-150 degrees in a clockwise or counterclockwise direction so that tool 238 is aligned in a second configuration 204. Second configuration 204 allows tool 238 to substantially fill slot 184 in a longitudinal direction thereby allowing tool 238 to push screen material 144 against the sides of slot 184. FIG. 20 shows seating tool 238 in second configuration 204. Portions 206 of tool 238 extend under tapered sides 196 of slot 184, thereby preventing tool 238 from being removed from slot 184 during step 107. Base 199 of tool 238 also pushes against screen material 144 to further position the screen material 144 within slot 184.

FIG. 21 shows how curable compound 182 is applied by dispensing tube 208. Compound 182 is extruded through tube 208 so that it exits out of tool 238 and onto screen material 144 after wheel 180 and seating tool 238 push screen material 144 into position in slot 184. The pressure of tool 238 on the extruded compound 182 positioned on screen material 144 and screen frame 120 helps apportion a suitable amount of compound 182 on screen material 144 so that proper curing may occur. According to a preferred embodiment, compound 182 is approximately 0.0275 inches thick after application. Compound 182 flows into slot 184 and takes the shape of the lower section of slot 184.

Once curable compound 182 has been applied to screen material 144 in slot 184, an ultraviolet light source 210 (as shown in FIGS. 15-17) is used to cure compound 182 by providing ultraviolet light to compound 182. Ultraviolet light source 210 is coupled to the screen assembly apparatus so that ultraviolet light is impinged into slot 184 as screen material 144 is positioned in slot 184 and compound 182 is extruded. A reflective system directs the ultraviolet light into slot 184 for curing compound 182 so that it will retain the shape of the lower section of slot 184. This prevents the newly formed screen compound combination from coming out of slot 184. Ultraviolet cure light source 210 preferably is of sufficient intensity that its close proximity to compound 182 will cause curing immediately. According to an exemplary embodiment, ultraviolet light with an input power in the range of about 200-800 watts over about a 1-7 inch length may provide sufficient curing of the compound. According to a preferred embodiment, ultraviolet light with an input power of about 500 watts over about a four inch length provides sufficient curing of the compound.

According to an exemplary embodiment, the compound may be cured with an ultraviolet light having a wavelength in the range of about 300 to about 450 nanometers. Further, the compound may be cured for a time in the range of about 1 to 3 seconds. Preferably, the compound is cured with an ultraviolet light having a wavelength of about 365 nanometers for about two seconds. Prior to curing, the compound may be applied (e.g., as a film, as a bead, etc.) to provide a layer having a thickness of about 0.015 to about 0.0425 inches. In addition, the compound may be applied so that the screen material is encapsulated such that the compound lies at or above a top surface of the screen material at the base of the tapered slot. Further, the compound may be applied so that an outer surface of the screen material located along a side of the tapered slot lies beneath an outer surface of the compound located along the sides of the slot.

Following the curing process, a trimming device 186 (e.g., an indexed multiple head knife blade) engages screen material 144 and trims excess material 144 against the outer edge 212 of slot 184 (from the inside of the slot as shown in FIGS. 15-17). Excess screen material 144 may then be “hidden” by the undercut of slot 184. In such an embodiment, the trimming device 186 is preferably configured to follow the ultraviolet light source 210.

When the trimming device 186 moves towards a corner portion of the screen frame assembly, the trimming device 186 moves between the screen bar 56 and the corner key 62. The configuration of the corner key 62 advantageously allows the trimming device 186 to exit the corner portion, while still providing an acceptable cut. The edge of the trimming device 186 follows a cut line 47 (shown in FIGS. 7 and 9) when entering the corner portion. Because of the configuration of the first component 93 of the incline 94, the trimming device 186 has a surface (e.g., either first channel wall 88 or second channel wall 90, etc.) against which the trimming device 186 can cut the excess screen material 54. After the trimming device 186 passes through the corner channel 86 of the corner key 62, the second component 95 of the incline 94 provides a gradual or softened passage or pathway through which the trimming device 186 can exit the corner key 62. The cutting edge of the trimming device will engage the incline 94 and will be guide upwards out of the corner key 62.

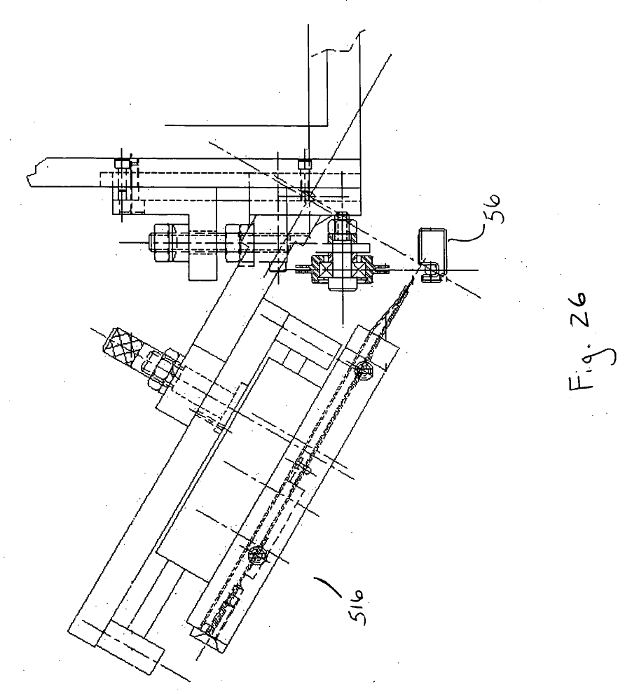

Referring generally to FIG. 25 and 26, a process for securing the screen material 54 to the screen frame assembly 50 is shown according to a second exemplary embodiment. Such an embodiment involves using an at least partially automated process to insert a spline 514 (shown in FIG. 9) into the spline groove 58 to secure the screen material 54 to the screen frame assembly 52. The steps include selectively positioning at least four 3-axis systems 502, 504, 506, and 508 relative to the screen bars 56 (each system 502, 504, 506, and 508 including a pair of operating or dispensing heads 510, 512), using the dispensing heads 510, 512 to dispense a spline 514 adjacent to the spline groove 58, securing the screen material 54 into screen frame assembly 52 by seating the spline 514 into the spline groove 58, and trimming excess screen material 54 with a trimming device 516 (shown in FIG. 26).

Similar to the method detailed above, the screen material 54 may be positioned over screen frame assembly 52 by the reels. As screen material 54 is advanced by the reels, the dispensing heads 510, 512 of the systems 502, 504, 506, and 508 are selectively positioned with respect to each screen bar 56 of the screen frame assembly 52. The dispensing heads 510, 512 are positioned by linear motors to a desired location for proper insertion of the spline 514 into the spline groove 58 located on the screen bar 56. The use of linear motors can minimize appreciable wear on items and increase accuracy and repeatability. Another advantage of linear motors is that they are very fast and have very dynamic response with no appreciable mechanical resonance.

Referring further to FIG. 25, the four systems 502, 504, 506, and 508 have an x-axis, a y-axis and a z-axis. The z-axis is used to move the dispensing heads 510 and 512 vertically up and down with respect to the screen bar 56. The x-axis linear motors are used to position the dual head “Y” axis over the screen frame assembly 52. The z-axis then lowers the dispensing heads into the screen frame assembly 52. Upon the completion of load step 107 and screen advance step 107, the four systems 502, 504, 506, and 508 are preferably positioned for engaging the screening material 54 into the spline groove 58 of each screen 56 within the screen frame assembly 52. A Computer system (not shown) sends parametric information to the drive controllers for the y- and x-axes and the z-axis for retraction from the previous screen completion sequence.

Commands from the computer system position the systems 502, 504, 506, and 508 at appropriate locations along different sized screen frame assemblies. In general, the x-axes represent areas of a screening machine that will engage a screen frame assembly along its length, top and bottom. These axes bring dispensing heads closer to the frame rails. Once the y-axes engage the edges of the frame rails, the z-axes lower to allow the dispensing heads to engage the screen material and frame slot and the y-axes become ready to traverse the frame slot to seat and attach the screen to the frame.

The dispensing heads 510, 512 work in-line with one another. Head systems 510, 512 may start at any location along the screen bar 56 as determined by the computer system. As the screening process begins, the y-axes traverse away from the starting location to a computer controlled end location. The z-axes then retract and the y-axes return to the starting location. If the next screen is a different size, the x-axes advance or retract as appropriate. Alternatively, any number of configurations and sequences for the systems are possible. For example, two separate dispensing head systems may move toward one another, away from one another, parallel to one another, before or after one another, etc. Further, the disclosed system is not limited to just dual head designs. The dispensing heads may include any number of configurations (e.g., single heads, triple heads, etc.).

According to an exemplary embodiment, the systems 502, 504, 506 and 508 are initially positioned by the computer at a centerline of each screen bar 56. Once the systems 502, 504, 506, and 508 are positioned, the dispensing heads 510, 512 of each system 502, 504, 506 and 508 move in opposite directions (i.e., away from each other) toward the corner portions of the screen frame assembly 52. Starting the dispensing heads 510, 512 at the centerline of each screen bar 56 and having them moving in opposing directions advantageously reduces the amount of time required to secure the screen material 54 to the screen frame assembly 52. This direction of movement (from a centerline towards a corner) is possible due, at least in part, to the inclines 94 provided in the corner keys 62 which allow trimming device to exit the corner without having to engage a 90 degree end wall. According to an exemplary embodiment, all of the dispensing heads 510, 512 provided along each of the four sides of the screen frame assembly 52 move at substantially the same time. As the dispensing heads 510, 512 move, they dispense the spline 514 to seat the screen material 54 in the spline groove 58. The dispensing heads 510, 512 further include a punch and/or roller configured to force the spline 514 and the screen material 54 into the spline groove 58.

With reference to FIGS. 3, 4 and 26, following the seating process, a trimming device 516 (e.g., an indexed multiple head knife blade) engages screen material 51 and trims excess screen material 54 against the side surface 55 of the screen bar 56. According to an exemplary embodiment, the trimming device 516 is supported on the dispensing heads 510, 512 so that the trimming device 516 moves with the dispensing heads. When the trimming device 516 moves towards a corner portion of the screen frame assembly, the trimming device 516 moves between the screen bar 56 and the corner key 62. The configuration of the corner key 62 advantageously allows the trimming device 516 to exit the corner portion, while still providing an acceptable cut. The edge of the trimming device 516 follows a cut line 47 (shown in FIGS. 7 and 9) when entering the corner portion. Because of the configuration of the first component 93 of the incline 94, the trimming device 516 has a surface (e.g., either first channel wall 88 or second channel wall 90, etc.) against which the trimming device 516 can cut the excess screen material 54. After the trimming device 516 passes through the corner channel 86 of the corner key 62, the second component 95 of the incline 94 provides a gradual or softened passage or pathway through which the trimming device 516 can exit the corner key 62. The cutting edge of the trimming device 516 will engage the incline 94 and will be guide upwards out of the corner key 62.

Once the screen material 54 has been attached to a screen frame assembly 52, the completed screen assembly 50 is preferably ejected from the screen assembly apparatus for stacking and shipping. According to an exemplary embodiment, the ejection system may comprise belted tangs that push the completed screen assembly 50 off of the platen for an operator to take and package it. This system can work in coordination with an inlet vacuum and locating system. In addition, the rollers and stops used to locate and affix the frame for secondary screening operations may continue to roll the screen out for ejection. These rollers may be made of materials that will be hard enough for good wear characteristics and pliable enough for effective location of the frame.

According to exemplary embodiments, the completion of the screen assembly 50 may require a release of pre-stressing tangs and/or a retraction of locating backstop tangs so that the frame can be ejected for bundling. Further, vacuum system valves can cycle to apply pressure to the frame thereby allowing easier ejection. This way, the vacuum system can remain at a pressure to allow for positioning of a screen frame when the screening process is restarted. In addition, ejection rollers may assist in the ejection process by activating and driving the completed frame out of the system.

In general, the screen assembly apparatus may comprise a PC based hierarchical control system including a central main computer with software for machine control. As FIG. 17 shows, a computer system 130 including a display system 214 and input device 216 may be used to control the screen assembly. According to the illustrated embodiment, a drive motion computer 218 controls each linear motor 159 which are connected to a high speed digital communication network 220. Computer system 218 may be connected with each linear motor 159 over a low speed digital communication network 222. A plurality of input/output (I/O) panels 224, 226, 228, 230, 232, 234, 236 allow a user to also monitor and control functions of various sensors and systems (e.g., vacuum system, linear motors, ultraviolet compound dispense valves, etc.) within the screen assembly apparatus.

It is important to note that the construction and arrangement of the elements of the corner key as shown in the exemplary embodiments are illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Further, the disclosed corner key may be suitable for use with any of a variety of methods of manufacturing a screen assembly. Accordingly, all such modifications are intended to be included within the scope of the appended claims. The order or sequence of any process or method steps may be varied or re-sequenced according to alternative embodiments. Other substitutions, modifications, changes and omissions may be made in the design, operating conditions and arrangement of the various exemplary embodiments without departing from the scope of the appended claims.

What is claimed is:

1. A corner connector for supporting a first screen bar relative to a second screen bar, each screen bar having a groove open toward a top surface and configured to receive a screen material that is subsequently trimmed by a cutting device, the corner connector comprising:
a base portion disposed between a first extension for supporting the first screen bar and a second extension for supporting the second screen bar, the base portion comprising a first end surface configured to be substantially coplanar with the top surface of the first screen bar and the top surface of the second screen bar;
a first incline defined by the base portion and ascending from a point below the first end surface, the first incline is configured to guide the cutting device out of the corner connector as the cutting device moves from the second screen bar to the base portion; and
a second incline defined by the base portion and ascending from a point below the first end surface, the second incline is configured to guide the cutting device out of the corner connector as the cutting device moves from the first screen bar to the base portion.

2. The corner connector of claim 1, wherein the base portion further comprises a first side wall from which the first extension extends and a second side wall from which the second extension extends.

3. The corner connector of claim 2 wherein the base portion further comprises a corner channel configured to provide a substantially continuous transition between the groove of the first screen bar and the groove of the second screen bar.

4. The corner connector of claim 3 further comprising a projection upwardly extending from the corner channel and aligned with the first side wall and the second side wall to define a pair of perpendicular channels which are configured to be aligned with the grooves of the first screen bar and the second screen bar.

5. The corner connector of claim 3, wherein the corner channel is defined by a first channel wall and a second channel wall, the first channel wall is configured to be substantially parallel with the groove of the first screen bar and substantially perpendicular to the groove of the second screen bar, the second channel wall is configured to be substantially parallel with the groove of the second screen bar and substantially perpendicular to the groove of the first screen bar.

6. The corner connector of claim 5, wherein the first incline ascends from a top edge of the first channel wall and the second incline ascends from a top edge of the second channel wall.

7. The corner connector of claim 6, wherein the first channel wall provides a cutting surface for the cutting device as the cutting device moves from the first screen bar to the corner connector and the second channel wall provides a cutting surface for the cutting device as the cutting device moves from the second screen bar to the corner connector.

8. The corner connector of claim 7, wherein the first channel wall slopes downward away from the first side wall and the second channel wall slopes downward away from the second side wall.

9. The corner connector of claim 1, wherein the first incline is substantially symmetrical to the second incline relative to an axis extending diagonally about the first end surface of the base portion.

10. The corner connector of claim 1, wherein the base portion further comprises a first channel and a second channel, the first channel is configured to be substantially collinear with the groove of the second screen bar, the second channel is configured to be substantially collinear with the groove of the first screen bar.

11. The corner connector of claim 10, wherein the first incline is at least partially provided in the first channel and the second incline is at least partially provided in the second channel.

12. The corner connector of claim 1, wherein the first channel extends between the first channel wall and an outer wall of the base portion and the second channel extends between the second channel wall and the outer wall of the base portion.

13. The corner connector of claim 12, wherein a bottom surface of the first channel and a bottom surface of the second channel ascend toward the outer wall.

14. The corner connector of claim 12, wherein the bottom surface of the first channel and the bottom surface of the second channel are substantially linear surfaces.

15. A screen assembly comprising:
a screen material;
a plurality of frame members secured together to form a frame assembly, each frame member having a groove for receiving the screen material; and
a plurality corner connectors disposed between adjacent frame members, each corner connector including a base portion defining a pair of exit ramps,
wherein the exit ramps comprises a surface configured to guide a cutting device used to trim the screen material.

16. The screen assembly of claim 15, wherein the sloped surface of each exit ramp comprises a first angular component for providing the cutting device with a pathway out of the corner connector and a second angular component for providing the cutting device with a cutting surface against which the cutting device can cut the screen material.

17. The screen assembly of claim 15, wherein the corner connectors further include a pair of channels defined by the base portion, the channels are substantially collinear with the grooves of the frame members and define the pair of exit ramps.

18. A method of manufacturing a screen assembly, the method comprising:
forming a frame assembly by securing at least a first frame member and a second frame member to a corner connector, the first frame member, the second frame member, and the corner connector cooperate to define a substantially continuous groove about the frame assembly;
positioning a screen material over the frame assembly so that a portion of the screen material overlays the groove;
securing the screen material in the groove; and
trimming the screen material with a cutting device,
wherein the cutting device is guided out of the corner connector by a surface defined by the corner connector.

19. The method of claim 18, wherein the step of securing the screen material in the groove includes the steps of dispensing a curable compound to the screen material and curing the compound.

20. The method of claim 18, wherein the step of securing the screen material in the groove includes the step of starting to dispense a spline at a centerline of the first frame member and moving towards a corner portion of the frame assembly.

21. The-method of claim 20, wherein the step of securing the screen material in the groove involves using a pair of operating heads for each frame member, the operating heads begin at the centerline of the respective frame member and move toward opposite ends of the frame member.

22. The method of claim 21, wherein the operating heads provided along the first frame member move simultaneously with the operating heads provided along the second frame member.
